(19) United States
(12) Patent Application Publication
(10) Pub. No.: US 2009/0317582 A1
(43) Pub. Date: Dec. 24, 2009

(54) SINTERED GEAR

(75) Inventors: Herbert Schmid, Vorchdorf (AT); Karl Dickinger, Vorchdorf (AT); Wolfgang Siessl, Traunkirchen (AT)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Miba Sinter Austria GmbH, Laakirchen (AT)

(21) Appl. No.: 12/354,114

(22) Filed: Jan. 15, 2009

(30) Foreign Application Priority Data
Jan. 16, 2008 (AT) GM 27/2008

(51) Int. Cl. B32B 3/02; B21K 1/30; B24B 1/00

(52) U.S. Cl. 428/66.1; 29/893.3; 451/47

(57) ABSTRACT

The invention relates to a sintered gear (1) with teeth (2), between which a tooth base (5) is respectively formed. The tooth base (5) has a surface which is subjected to a thermo-mechanical finishing process and a surface roughness with an arithmetical mean roughness value Ra, measured in accordance with DIN EN ISO 4287, selected from a range with a lower limit of 0.2 μm and an upper limit of 2.0 μm.

### BACKGROUND OF THE INVENTION

The invention relates to a sintered gear with teeth, between which a tooth base is respectively formed, as well as a method of producing the sintered gear with improved ability to withstand mechanical stress.

It is becoming increasingly common for components manufactured by means of conventional molten metallurgical methods to be replaced by components made by powder metallurgy, not least because they are easier to produce in more complex geometries. Due to the manufacturing method, however, sintered components do not have high strength unless treated, due to the residual porosity of these sintered components. In one respect, this residual porosity is desired, for example in the case of sintered components intended for use in lubricated systems, in which case the pores can be used as reservoirs for lubricant. Various methods of reducing this residual porosity have already been proposed in the prior art as a means of improving ability to withstand mechanical stress, for example compacting the surface of gears by radial pressing or rolling. To date, however, treating the tooth flanks by a surface hardening or surface compaction process with a view to increasing the ability to withstand mechanical stress as the primary aim has meant deliberately reducing hardness in the tooth root region in order to improve mechanical properties.

For example, patent specification DE 10 03 779 A1 describes case-hardened gears subjected to surface pressure and flexing with good strength properties in terms of flexing endurance. To this end, the areas subjected to flexing, in other words the tooth base parts, have a lower surface hardness or case-hardened depth and the surface hardness in the tooth base part is approximately within the range of between 48 and 58 HRc. In order to produce these gears, they are firstly case-hardened using a known method and after hardening, some of the hardened layer at the tooth base is removed again and is so with a view to preserving as uniform a transition as possible of the hardness value from the tooth base to the active tooth flank profile, for example by grinding.

Patent specification DE 25 56 170 A1 discloses a method of increasing the hardness of hardened and/or heat-treated gears, at least with respect to the tooth flanks, whereby the region where the tooth flanks merge into the adjacent tooth base is rounded. In this respect, the rounded transition is refined by a surface treatment directed transversely to the longitudinal extension of the teeth, for example by grinding and/or polishing. The intention is to ensure that the scoring produced by processing extends transversely to the longitudinal direction of the teeth so that it lies on the teeth in the plane disposed in the direction in which forces acts on them and not perpendicular thereto. This reduces fatigue notch sensitivity in the tooth base region and increases the bearing capacity of the gear.

Patent specification DE 11 79 081 A1 discloses a method whereby the tooth base and fillets adjoining the tooth base and the tooth flanks are ground out and optionally polished in order to prevent abrasion cracks at the tooth base of gears.

Patent specification DE 29 34 413 A1, finally, discloses a method of simultaneously processing the tooth base by grinding in conjunction with gear-grinding the tooth flanks.

In the case of sintered gears, the tooth base has not been subjected to such finishing processes in the past, on the one hand in order to avoid reducing the surface hardness, as described in DE 10 03 779 A1 mentioned above, and also to enable the pores in the tooth base region to be used as “lubricant pockets”.

The objective of this invention is to improve the ability of a sintered gear to withstand mechanical stress.

This objective is achieved by the invention on the basis of a sintered gear and the tooth base has a surface which is subjected to a thermo-mechanical finishing process and has a surface roughness with an arithmetical mean roughness value Ra, measured in accordance with DIN EN ISO 4287, which is selected from a range with a lower limit of 0.2 μm and an upper limit of 2.0 μm, and on the basis of a method of producing the sintered gear whereby its tooth base is subjected to thermo-mechanical processing until this surface roughness is imparted to the tooth base. Surprisingly, it has been found that subjecting the tooth base to thermo-mechanical processing improves resistance of the tooth to breaking by avoiding abrasive cracks, and in addition, especially in the event of inadequate cooling of the processed surface, the thermo-mechanical processing of this surface also induces stresses in the tooth base, thereby enabling the internal stress profile in this region and hence the ability of a sintered gear to withstand mechanical stress to be increased. The strength is therefore higher—than sintered gears not subjected to a finishing process—by up to 20%. Due to the internal stress induced by pressure, it is possible to achieve levels of strength close to those which can be obtained from solid material, and in particular, the gap between solid steel gears and gears made from sintered materials, which currently have a 20% lower mechanical strength, can be reduced by up to 10%. With the sintered gear proposed by the invention, strength levels can be achieved which are comparable with those of solid gears, which means that the case width of such sintered gears can be increased. Thermo-mechanical processing with inadequate cooling likewise leads to a plasto-mechanical hardening of the peripheral layer, as a result of which the porosity in these peripheral layers can also be reduced. This means that an additional surface compaction can be achieved and, generally, that a surface compaction can be applied if this has not been done prior to the thermo-mechanical finishing process. This finishing process also enables the accuracy of the tooth geometry to be increased, thereby reducing the play between mutually meshing gears and hence also improving the acoustic properties of such a transmission, i.e. imparting a low noise level. Another advantage is the fact that due to “strain hardening”, the temperature stress in this surface region is relatively low, which means that re-crystallisation does not occur and there is therefore no drop in stress. With this method, it also possible to reduce the cost of manufacturing such sintered gears because the standard process of irradiating this surface that has been used to date can be dispensed with. This finishing process also reduces flitter caused by the process of rolling the tooth flanks. At the same time, any brittle hard layers can be removed from the surface if necessary.

In particular, the surface roughness also has an arithmetical mean roughness value Ra, measured in accordance with DIN EN ISO 4287, which is selected from a range with a lower limit of 0.6 μm and an upper limit of 1.2 μm.

In order to increase mechanical strength and further improve acoustic values, it is of advantage if the surface of the tooth base of the sintered gear has a maximum roughness profile value R3z, measured in accordance with DBN 31007, which is selected from a range with a lower limit of 0.5 μm and an upper limit of 8 μm.

In particular, the surface of the tooth base has a maximum roughness profile value R3z, measured in accordance with DBN 31007, which is selected from a range with a lower limit of 1 μm and an upper limit of 5 μm.

In terms of improving ability to withstand stress and increasing the service life of the sintered gear, it is also of advantage if the tooth base superficially has at least the same hardness as the surface of the adjoining tooth flanks and the adjoining rounded regions of the transitions to the tooth flanks.

In one embodiment of the sintered gear, the surface of the tooth base has a residual porosity of at most 12%. Surprisingly, it has been found that such a low residual porosity still assists lubrication of a geared transmission with a sintered gear proposed by the invention to a sufficient degree that, in conjunction with the improved ability to withstand mechanical stress, i.e. the strength of the sintered gear, the service life itself can be further improved.

In one embodiment of the method proposed by the invention, the thermo-mechanical finishing process is conducted with a polishing means which has a grain size selected from a range with a lower limit of 50 and an upper limit of 150. With polishing means with grain sizes specifically selected from this range, it has been found that a further increase can be achieved in the internal stress induced.

In this connection, it is also of advantage if the finishing process is conducted with a polishing means with a grain size selected from a range with a lower limit of 70 and an upper limit of 110, and has a grain size of 90.

### BRIEF DESCRIPTION OF THE DRAWING

To provide a clearer understanding of the invention, it will be explained in more detail below with reference to the appended drawing. The drawing

FIG. 1 shows a schematic detail of the toothing region of a sintered gear.

### DETAILED DESCRIPTION

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described. Individual features or combinations of features from the different embodiments illustrated and described may be construed as independent inventive solutions or solutions proposed by the invention in their own right.

All the figures relating to ranges of values in the description should be construed as meaning that they include any and all part-ranges, in which case, for example, the range of 1 to 10 should be understood as including all part-ranges starting from the lower limit of 1 to the upper limit of 10, i.e. all part-ranges starting with a lower limit of 1 or more and ending with an upper limit of 10 or less, e.g. 1 to 1.7, or 3.2 to 8.1 or 5.5 to 10.

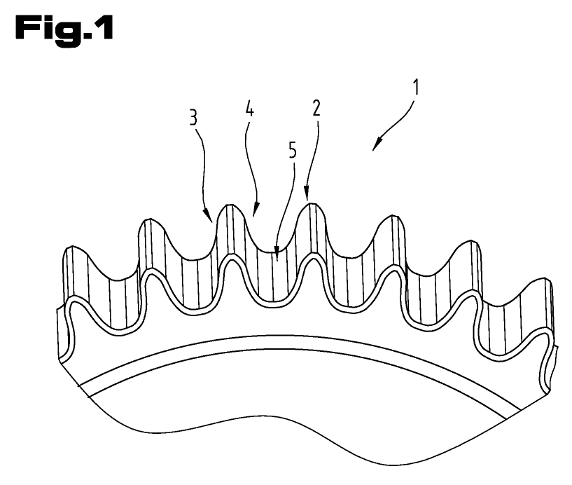

FIG. 1 illustrates a detail of a sintered gear 1. This sintered gear 1 has teeth distributed around an external circumference of the sintered gear 1.

The expression sintered gear within the meaning of the invention should be construed as meaning a gear made from a sintered material. Materials which might specifically be used for this purpose are aluminium, iron, copper, magnesium, titanium and alloys thereof. Examples of such sinter metal alloys may be found in DIN V 30 910 Part 4, page 3. In particular, a sintering steel is used which contains one of the elements comprising copper, nickel, manganese, chromium, silicium, molybdenum, vanadium. This sintering steel may also contain carbon in a proportion of up to 0.65% by weight. For example, sintering steels of the following composition may be used: carbon 0.2% by weight, magnesium <0.1% by weight, molybdenum 0,85% by weight, the rest being iron with the impurities induced by the manufacturing process, or carbon 0.3% by weight, chromium 1.5% by weight, molybdenum 0.25% by weight, the rest being iron with impurities induced by the manufacturing process.

Processing aids for the sintered components may be added to these powders, such as manganese sulphide.

All the figures given in connection with the composition refer to the finished alloy.

In order to produce these alloy powders, the individual metals may be mixed with one another or alternatively, powders which have already been pre-alloyed may be used.

Since the skilled person will be familiar with the method used to produce sintered components, reference may be made to the relevant background literature. In particular, the process of producing sintered components involves the method steps of mixing the powder, optionally with additives and agents, such as anti-friction agents or lubricants for example, compacting the powder to produce a green compact, sintering the green compact, and if necessary calibrating and/or re-compacting the sintered components. Production may also include case-hardening or tempering such components.

In a known manner, the teeth 2 each have a left-hand and a right-hand tooth flank 3, 4 as well as a tooth base 5 adjoining them. The two tooth flanks 3, 4 are preferably ground.

For the purpose of the invention, the tooth base 5 is subjected to a thermo-mechanical process, in particular by grinding and/or honing. The grinding or honing takes place in the axial direction of the sintered gear 1. This produces a surface roughness of the sintered gear in the region of the tooth base 5 with an arithmetical mean roughness value Ra corresponding to the explanations given above. It is preferable to select a maximum roughness profile R3z in the region of the tooth base 5 from the range specified above.

The two tooth flanks 3, 4 may also have these same values of mean roughness and optionally the same roughness profile value.

As illustrated in FIG. 1, the edge in the region of the transition from the surface of the teeth in the region of the tooth flank 3, 4 as well as the tooth base 5 to the surface in the radial direction of the sintered gear 1 may be stepped, which also enables the ability of the sintered gear 1 gear to withstand stress to be increased, and in particular facilitates engagement for additional meshing of the sintered gear 1.

The following tests were conducted whilst experimenting with the invention.

### EXAMPLE 1

An alloy powder of the following composition was used to produce a sintered gear 1 as proposed by the invention:

carbon 0.2% by weight, magnesium <0.1% by weight, molybdenum 0.85% by weight, the rest being iron with impurities induced by the manufacturing process.

This alloy powder was compacted at a pressure of 700 MPa to obtain a green compact and then sintered at a temperature in the range of between 1100° C. and 1350° C. This was followed by a calibration of the sintered gear 1 with the aid of a die by pressing it through the die.

As an alternative to pushing it through the die, the component may be ejected from the die in the direction in which it was introduced into it.

The resultant sintered gear 1 had a core density of ca. 6.9 g/cm³ and a surface density greater than 7.4 g/cm³.

It should be pointed out that the entire sintered gear 1 may be of approximately the core density if processing a non-compacted material.

Following the surface compaction, i.e. calibration and optionally a thermo-chemical treatment or hardening, the tooth flanks 3, 4 as well as the tooth base 5 were ground with a grinding means with a grain size of 90.

Using the pulsator test on this sintered gear 1, it was found to have a tooth base strength of 870 MPa.

By comparison, a sintered gear was produced by all the method steps except that of grinding the tooth base 5. In the pulsator test, this comparable gear was found to have a tooth base strength of 700 MPa-750 MPa.

By comparison with this, a gear made from solid steel, in other words manufactured by molten metallurgy, has a tooth base strength of 920 MPa auf.

### EXAMPLE 2

A sintered gear 1 was produced in the same way as explained in connection with example 1, care being taken to ensure that the surface of the tooth flanks 3, 4 and the tooth base 5 were of approximately the same hardness. This hardness was between 650 HV0.1 and 870 HV0.1. The pulsator test produced the same ratios as those given in example 1.

Both the sintered gear 1 based on example 1 and that based on example 2 had a residual porosity of max. 12% in the region of the surface of the tooth flanks 3, 4 and the tooth base. In particular, the residual porosity in example 1 was 5.1% and that based on example 2 was 4.5%.

### EXAMPLE 3

Example 1 was essentially repeated and a grinding means with a grain size of 90 was used so that the surface of the tooth base 5 had a max. roughness profile value R3z, measured in accordance with DBN 31007, of 4.2 μm. The pulsator test produced the same ratios as specified in example 1.

### OTHER EXAMPLES

Example 1 was repeated several times but the surface roughness was varied within ranges of 0.2 μm to 3.0 μm and the max. roughness profile value was varied within ranges of 0.3 μm to 15 μm. Results showed that particularly good ability to withstand mechanical stress was obtained in the ranges from 0.2 um to 2.0 μm for Ra and from 0.5 μm to 8 μm for R3z.

In addition to increasing strength, the method proposed by the invention has a side-effect in that toothing errors caused by the manufacturing process can be at least largely compensated.

The thermo-mechanical finishing process subjects the surface to a temperature stress selected from a range with a lower limit of 10° C. and an upper limit of 250° C. In particular, the method is conducted with inadequate or no cooling of the processed surface, i.e. the tooth base 5 and/or the tooth flanks 3, 4.

The embodiment described as an example represents one possible variant of the sintered gear 1 and it should be pointed out at this stage that the invention is not specifically limited to the variants specifically described, and instead other variants are possible, for example spiral gearing, bevel gearing, etc., and these possible variations lie within the reach of the person skilled in this technical field given the disclosed technical teaching. Accordingly, all conceivable variants which can be obtained by combining individual details of the variants described and illustrated are possible and fall within the scope of the invention.

For the sake of good order, finally, it should be pointed out that, in order to provide a clearer understanding of the structure of the sintered gear 1, it and its constituent parts are illustrated to a certain extent out of scale and/or on an enlarged scale and/or on a reduced scale.

1. Sintered gear with teeth, between which a tooth base is respectively formed, wherein the tooth base has a surface which is subjected to a thermo-mechanical finishing process and has a surface roughness with an arithmetical mean roughness value Ra, measured in accordance with DIN EN ISO 4287, selected from a range with a lower limit of 0.2 μm and an upper limit of 2.0 μm.

2. Sintered gear as claimed in claim 1, wherein the surface of the tooth base has a maximum roughness profile value R3z, measured in accordance with DBN 31007, selected from a range with a lower limit of 0.5 μm and an upper limit of 8 μm.

3. Sintered gear as claimed in claim 1, wherein the tooth base superficially has at least approximately the same hardness as the surfaces of the tooth flanks.

4. Sintered gear as claimed in claim 1, wherein the surface of the tooth base has a residual porosity of at most 12%.

5. Method of producing a sintered gear with improved ability to withstand mechanical stress, whereby the sintered gear has teeth, between which a tooth base is respectively formed, wherein the tooth base is subjected to a thermo-mechanical finishing process until a surface roughness with an arithmetical mean roughness value Ra, measured in accordance with DIN EN ISO 4287, selected from a range with a lower limit of 0.2 μm and an upper limit of 2.0 μm is imparted to its surface.

6. Method as claimed in claim 5, wherein the thermo-mechanical finishing process is conducted with a grinding means with a grain size selected from a range with a lower limit of 50 and an upper limit of 150.
